(19) United States
(12) Patent Application Publication
(10) Pub. No.: US 2016/0348348 A1
(43) Pub. Date: Dec. 1, 2016

(54) SANITARY APPLICATOR FOR SELF-ADHESIVE COMPOSITIONS

(71) Applicant: EURVEST SA, Nivelles (BE)

(72) Inventors: Agnieszka SIKORSKA, Trawniki (PL); Alain LUCIANI, Auriol (FR); Jean KLIMIS, Bruxelles (BE); Estelle BERTIGNON, Mons (BE)

(73) Assignee: EURVEST SA, Nivelles (BE)

(21) Appl. No.: 15/116,728

(22) PCT Filed: Feb. 11, 2014
(86) PCT No.: PCT/EP2014/052671

§ 371 Date: Aug. 4, 2016

(51) Int. Cl. E03D 9/02; C09J 7/02; C11D 3/00; C09J 9/00; C11D 17/00; C11D 17/04

(52) U.S. Cl. CPC E03D 9/022; C11D 17/0056; C11D 17/046; C11D 3/0068; C09J 9/00; C09J 7/02

(57) ABSTRACT

The present invention is directed to a non-soluble and non-removable applicator for applying self-adhesive composition onto the wall of sanitary elements, preferably a toilet basin.

### FIELD OF THE INVENTION

The present invention relates to sanitary composition for cleaning and/or disinfecting and/or deodorizing sanitary elements, especially toilets. It particularly relates to the application of self-adhesive products onto the sanitary elements, preferably detergent compositions.

### TECHNICAL BACKGROUND

Several solutions exist for cleaning and/or disinfecting and/or deodorizing sanitary elements, especially toilets. A first solution consisted in a block placed in cage.

Self-adhesive detergent compositions which can be applied directly to the wall of a sanitary element are also known in the art. They correspond to solid, semi-solid or gel substances which are applied over the wall of a sanitary element, for example the falence of the toilet. These compositions have cleaning and/or disinfecting and/or deodorizing properties and are continuously washed off their supporting wall with the flushes.

Nevertheless, it is desirable to prevent the contact of the detergent composition with the hands of the user which may cause discomfort and/or chemical contaminations. Different applicator devices have thus been developed to prevent any direct contact while the product is handled, positioned and adhered to the sanitary element.

For example, WO-A-2007/008531 discloses a device which includes a tubular body and a plunger. The flowable detergent material, contained inside the body of the device, is dispensed through an orifice in controlled unitized doses to a surface when the plunger is moved toward the body by the user. However, this type of applicator is complex to manufacture, involves substantial amounts of environmentally unfriendly materials, and may be unhygienic since the same device is applied several times to the wall of sanitary elements over extended period of times to apply the doses. The device is systematically removed after application of the adhesive compositions.

In WO-A-2011/135330, the self-adhesive composition is contained in a cavity and applied to the wall of the sanitary element with a piston which is moveably engageable within the cavity. The applicator is removed after application of the adhesive composition. This solution also involves similar constraints since the device has a complex shape while it requires high amounts of material, such as plastic, to manufacture the grip. In addition, the device is intended to be reused for several applications.

EP-A-2141221 discloses a self-adhesive preformed detergent product which is provided inside a containment portion made from flexible or rigid material. Such portion is used to stick a preformed detergent product directly onto the surface of the sanitary apparatus while preventing any direct contact of the user with the detergent composition. However; the containment portion still needs to be removed after application. As shown in FIGS. 7a-d of the document, the method of application of a self-adhesive detergent product shows that the device is manipulated with both hands of the users, to grip and remove the containment portion which may be constraining.

In WO 2008/100393, the detergent and adhesive composition is provided between two solid substrates which both need to be removed before use of the composition. The first substrate is removed to apply the adhesive composition directly onto the wall of the toilet. There is also still the need to manipulate the product into the toilet basin after application to remove the second substrate before use.

Additional sanitary products were disclosed to facilitate the process of application of the detergent composition. Particularly, some compositions are provided in a soluble plastic film which itself becomes adhesive when applied on a wet sanitary wall. Such products are disclosed for example in WO 2012/017276. However, these products do not take advantage of the adhesive properties of the detergent composition itself and may be difficult to apply as one has to wait until the film is fully wetted to adhere. Also, it appeared that the surrounding film exhibits limited mechanical properties and need to be substantially dissolved before the detergent composition can actually come in contact with the water.

In the European patent application EP13156652.3, adhesive compositions are applied with a soluble and disposable applicator.

However there remains a strong felt need for adhesive products which are easy to manufacture and use and remain safe to the user.

### FIGURES

FIGS. 1 to 7 are non-limiting examples of applicators according to the instant invention.

### SUMMARY OF THE INVENTION

The applicant has surprisingly discovered that the drawbacks of the prior at could be overcome with the products according to the invention. It has been found that the claimed applicators are easy to manufacture, safe to any user and substantially facilitate the application of the product in sanitary facilities. The applicators and products according to the invention can be safely manipulated by the user without any risk of chemical contamination and resists a sufficient force to stick the composition onto the sanitary element with a single hand. The user does not have to remove either the applicator after the self-adhesive composition is applied onto the sanitary element which considerably simplifies the use of the product. The applicator according to the instant invention also simplifies the formulation of the compositions used into the sanitary installations.

A first aspect of the invention is concerned with a non-soluble and non-removable applicator for self-adhesive composition, preferably a self-adhesive detergent composition.

According to one embodiment of the invention the applicator is made is of one or mixtures of materials selected among: paper and paperboard based materials; biodegradable plastics; wax based materials; cotton based materials; wood based materials; or soap based materials.

According to one embodiment of the invention, the applicator comprises at least one biodegradable material.

According to one embodiment of the invention, the applicator comprises at least one of: aromatic polyesters, polyhydroxyalkanoates (PHAs) such as poly-3-hydroxybutyrate (PHB), polyhydroxyvalerate (PHV); polyhydroxyhexanoate (PHH); polylactic acid (PLA); polybutylene succinate (PBS), polycaprolactone (PCL); polyanhydrides; polyvinyl alcohol, starch derivatives cellulose esters such as cellulose acetate and nitrocellulose and their derivatives (celluloid); poly-L-lactide (PLLA) poly-DL-lactide (PDLLA), polyglycolic acid (PGA), modified PET or mixtures thereof.

According to one embodiment of the invent n, the applicator further comprises a grip portion.

According to one embodiment of the invention the grip portion corresponds to a protruding portion or finger receiving cavities.

According to one embodiment of the invention the applicator comprises at least two curved arms (3) that are radially oriented.

According to one embodiment of the invention the applicator further comprises pores and/or at least one hole therein.

According to one embodiment of the invention the applicator further comprises an additive such as disinfectants, perfume, insecticides, enzymes, colored particles, preservatives, biocides, anti-lime scale, dyes, colorant and/or antibacterial agents therein in an amount of from 0 to 20 wt % of the total weight of the applicator, preferably from 1 to 5 wt %.

Another aspect of the present invention is directed to a self-adhesive product comprising a self-adhesive unit composition, preferably a self-adhesive detergent unit composition, which is attached to non-soluble and non-removable applicator according to the invention.

According to one embodiment of the invention at least one portion of the self-adhesive unit is left available to adhere to a wall and one portion is left available to the surrounding water after application.

According to one embodiment of the invention at least part of the applicator is embedded into the self-adhesive unit composition.

According to one embodiment of the invention the self-adhesive product further comprises one of its sides a peelable film onto the self-adhesive composition.

Another aspect of the present invention is directed to a process for the manufacture of an applicator according to the invention comprising (a) the mixing of the ingredients into a solvent or mixture of solvents, (b) removing at least part of the solvent to harden the form thus obtained and (c) shaping the paste thus obtained into the desired shape, for example by molding or injection.

Another aspect of the present invention is directed to the use of the self-adhesive product according to the invention into a sanitary element, preferably a toilet basin.

According to one embodiment of the invention, the use is for cleaning, disinfecting and/or deodorizing said sanitary element.

### DESCRIPTION OF EMBODIMENTS OF THE INVENTION

The present invention is disclosed in more details in the description that follows.

The applicators according to the instant invention are non-removable applicators. This means that the applicators are disposable after use. More particularly, this implies that the applicator remains attached to the self-adhesive composition to be applied. This term is used in opposition to the applicators used repeatedly to apply several doses of the composition or to the handling components which need to be removed before the user can actually use the composition.

The applicators are made of materials which are solid (in opposition to the liquid state) at room temperature but are non-soluble. Typically, materials which are non-soluble exhibit a solubility which is below about 100 g/L in water at 20° C.

One in the field will thus understand that the materials which are useful for the applicators according to the invention are any of the biodegradable materials, which means that they can break down as a result of a chemical, physical biological or thermic phenomenon within a limited time frame. Biodegradable materials typically encompass compostable materials. Characterization of a biodegradable material can be established according to the European standard NF EN 13432 or EN 14995.

Appropriate biodegradable materials can be natural or synthetic materials. Typically they are selected among one or several of the following categories:
a) Paper and paperboard based materials;
b) Biodegradable plastics;
c) Wax based materials;
d) Cotton based materials;
e) Weed based materials;
f) Soap based materials.

Within the present invention, the category biodegradable plastics encompasses polyhydroxyalkanoates (PHAs) such as poly-3-hydroxybutyrate (PHB), polyhydroxyvalerate (PHV) and polyhydroxyhexanoate (PHH); Polylactic acid (PLA); Polybutylene succinate (PBS), polycaprolactone (PCL) Polyanhydrides; polyvinyl alcohol; starch derivatives; cellulose esters such as cellulose acetate and nitrocellulose and their derivatives (celluloid); poly-L-lactide (PLLA) poly-DL-lactide (PDLLA), polyglycolic acid (PGA), modified PET.

Such materials can then be safely eliminated in the waste with the flush of a toilet without causing any harm to the environment. This way, the applicator can be easily manipulated by the user to apply the self-adhesive composition and left with the product after application. Advantageously, the applicators according to the invention are small enough to avoid any risk of blockage of the drain, e.g. wherein none of the length or width or height of the applicator is above 2.5 cm, preferably above 2.0 cm.

According to one embodiment of the instant invention, it is now possible to provide an applicator consisting essentially of one type of material. In the present context, the term “consisting essentially” is meant to exclude any component or mixtures of component. Typically, this term defines that at least 98% w/w of the composition of the applicator is made of the same material, preferably at least 99% w/w and more preferably at least 99.5% w/w.

Albeit the applicators according to the invention can be made of a single forming material, they may also include additives, i.e. processing or formulation additives. Other suitable additives promote the degradation and/or detachment of the applicator when in contact with water. Within the meaning of the present application, additives mean for example disinfectants, insecticides, enzymes, particles such as colored PET or PP, preservatives, biocides, anti-lime scale but also dyes or colorant and/or antibacterial agents. The total amount of additives is generally within the range of 0% to 20%, preferably from about 1% to 20%, more preferably from about 1% to 5% of the total weight of the applicator.

The applicators according to the instant invention can further comprise perfume. Appropriate perfumes are for example disclosed at paragraph [0064] of US 2008/0255017 which is incorporated herein by reference. The fragrance can be based on flowers fragrance, fruits, spices, and the like. The perfume can be of natural origin or can be synthetized. It is present generally in an amount from 0.1% to 25%, preferably from 1% to 20% by weight of the total applicator. The addition of perfume directly into the applicator is particularly useful since perfume may alter the behavior and properties of self-adhesive compositions when incorporated therein, i.e. in detergent compositions. Adding the perfume into another element of the sanitary product thus simplifies the formulation of the self-adhesive composition.

The applicator according to the instant invention can disappear with the water before the detergent dose is completely dissolved.

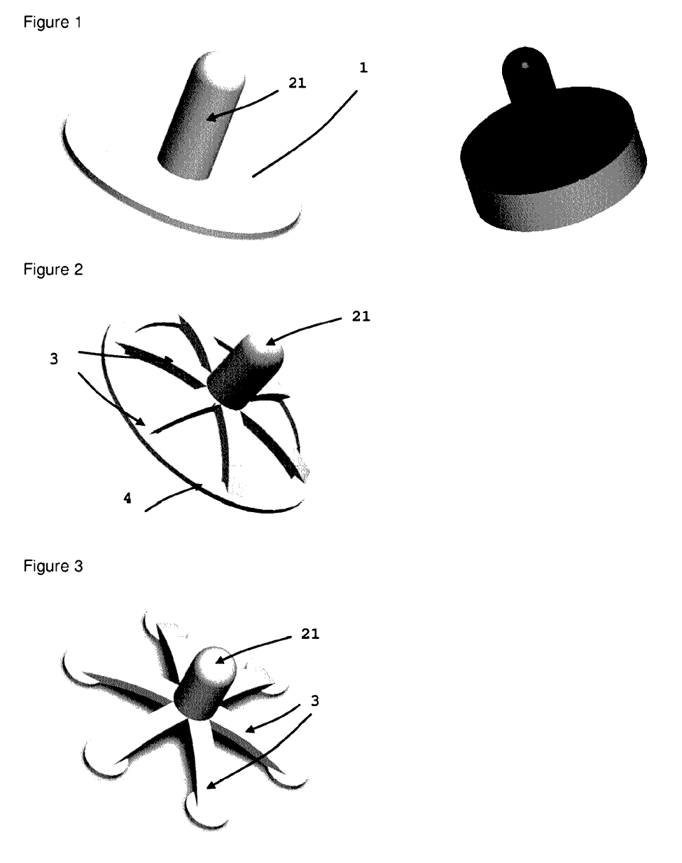

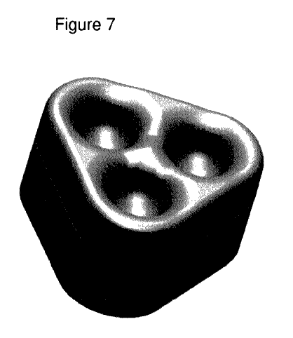

The applicators of the invention can have various shapes, such as rosette shapes or different visual aspects. The affordable materials which come into the composition of the applicators make it possible to easily adapt the visual aspect of the product and offer different shapes to the user. Appropriate shapes are similar to those disclosed in the European patent application EP13156652. An example of shape of an applicator according to the instant invention is illustrated in FIGS. 1 to 4. FIGS. 1, 2, 4 and 5 illustrate a typical circular applicator. FIG. 3 illustrates a typical rosette shaped applicator having arms which are oriented radially. FIG. 6 illustrate an example of a different shape of the platform. Other different shapes can be envisaged by the skilled man. FIG. 7 illustrate a square applicator which covers one of the surfaces of the composition.

The grip portion corresponds to an element which as such, can be seized by the user with the fingers of a single hand, e.g. two or three fingers to handle the entire product and parts which are related to such portion. The term generally implies that the portion has a limited size in comparison to the rest of the geometry of the sanitary product, i.e. within the same order of magnitude than the size of a phalanx or width of a finger. The grip portion must be located on the surface which is opposite to the surface to be adhered to the sanitary wall.

A first appropriate grip portion corresponds to a protruding portion. Typically, the protruding portion has a thickness falling for example within the range of about 0.5 to about 50 mm, preferably about 2 to about 30 mm, and roost preferably about 5 to 15 mm.

According to another embodiment of the invention, the applicator can be handled by the user with finger receiving cavities that are carved out in the volume of the applicator. An example of such applicator is illustrated in FIG. 7. This embodiment is advantageous in comparison to the grip portion being in the form of a protruding element, as it can prevent the splash-back during use. Two are sufficient to allow the user to seize the product. Three cavities provide further seizure capabilities and ensure that the product does not accidently gets away from the fingers of the user.

Typically, the cavities are all located on the surface which is opposed to the surface to be directed towards the sanitary wall to make sure the user does not have to hold both sides of the product with his fingers which triggers a risk that he gets in contact with the wall of the sanitary element Alternatively, the cavities can be located at the side of the applicator perpendicular to the sanitary wall.

Typically, the finger receiving cavities exhibit a depth within the range of about 0.6 to about 16 mm, preferably about 2 to 10 mm, and most preferably of about 8 mm. The depth of each cavity does not have to be the same and can be different.

The products made according to the instant invention are intuitive and easy to manipulate and use. They can be applied with one hand only without any risk for the user to touch with the fingers the surface of the sanitary wall.

The size and thickness of the applicator is such that it bears the significant mechanical stress resulting from the pressure applied by the user when fixing the self-adhesive product onto the wall of the sanitary element. Typically, this stress corresponds to about 25 N. Typically, the thickness of the applicator is comprised within the range of about 0.6 to 16 mm, preferably about 2 to 10 mm.

The applicator can be provided separately from the detergent doses, or advantageously attached to a self-adhesive composition into a ready to use product.

This second alternative offers the user the possibility to pick and apply directly the self-adhesive composition onto the sanitary surface without touching the composition and the sanitary element. The applicators according to the invention are intuitive and easy to manipulate and use. They can be applied with one hand only.

Typically, the applicator is applied on a surface of the self-adhesive composition. A portion of the composition must be available to adhere to the wall of the sanitary element on which it is applied. Also, once applied, at least one portion of the composition must be accessible to the surrounding water in order to release the detergent or active ingredients contained therein.

The applicator can thus be attached to the self-adhesive composition in various different ways provided it does not prevent the contact of the composition with the surrounding water. Said applicator can cover up to 90% of the surface of the self-adhesive composition which is not in contact with the wall of the sanitary element.

Typically, the applicator according to the instant invention can be fixed onto the composition in such way that said applicator covers partially the composition.

In another embodiment, the applicator can be partially embedded into the self-adhesive composition. in this case, part of the applicator remains accessible to the user for him to seize and handle the product without directly touching the composition itself.

The instant invention also aims to cover applicators which comprise pores or holes to allow the water to reach the composition.

According to a preferred embodiment, the applicator is shaped in such way that it forms a protruding portion or grip which can be seized and handled by the fingers of the user. The grip itself may have different forms while having a size which allows its manipulation. An appropriate length may fall for example between 5 and 25 mm, preferably between 10 and 20 mm.

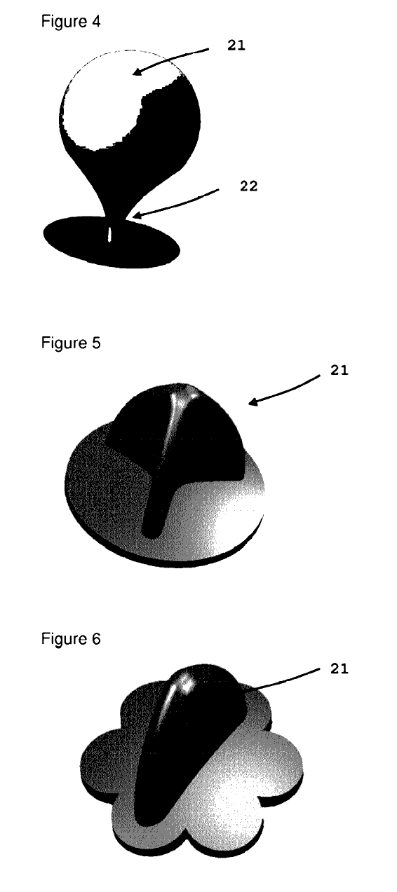

According to another embodiment, it may be useful to allow the grip of the applicator to be detached from the rest of the product once it is placed and fixed onto the wall of the sanitary element to provide an improved esthetic look. Particularly, the user can break the grip off the applicator, i.e. with a twist after he has fixed the product onto the wall of the sanitary element. This can be envisaged by providing a breaking line onto a portion of the protruding grip of the applicator or design a portion which exhibits a weaker resistance in comparison to the rest of the applicator. For example, the applicator represented in FIG. 4 comprises a grip with a different width along the length of the portion to facilitate the separation of the grip at the site where it is attached to the rest of the applicator. Different designs can also be envisaged by the skilled person.

The form of the applicator is such that it does not completely cover the inner and outer surface of the self-adhesive composition, to let, on the one hand one portion of the composition stick to surface of the sanitary wall and on the other hand, let the composition come in contact with the water once the product is applied onto the wall.

Typically, the applicator may form a cavity which is opened on the two ends in which the self-adhesive composition is placed or a platform on which a self-adhesive composition is placed. According to another preferred embodiment, the applicator comprises curved arms oriented radially from a central point in a similar shape of a semi-sphere. The curved arms thus form a cavity that can contain the self-adhesive composition.

The figures illustrate examples of applicators according to the instant invention. In FIG. 1, the applicator has the shape of a plateform on which the self-adhesive composition is placed (on the opposite side of the side comprising the grip (21)). A surface of the composition is thus left available to adhere to the wall of a sanitary element while at the same time the thickness of the composition remains accessible to the running water after the product is applied. FIGS. 2 and 3 illustrate an applicator according to the invention comprising six banded arms (3) and a grip (21). The arms can be connected one with each other or simply spread radically from the center of the applicator. The composition is placed on the opposite side of the surface having the grip. After application to the wall of a sanitary element, the portions (4) between the arms allow the water to come in contact with the composition. The applicator of FIG. 4 has the shape of a plateform on which the self-adhesive composition is placed (on the opposite side of the plateform comprising the grip) and works similarly as in FIG. 1.

The applicators according to the invention can be prepared and shaped using conventional methods.

One typical way of preparing the applicators according to the invention comprises:
mixing the ingredient in an appropriate solvent or mixture of solvents,
removing at least part of the solvent in order to harden the thus obtained form, for example by heating.
shaping the paste thus obtained into the desired shape, for example by injection or molding and optionally by pressing.
The solvent is removed until the shaped paste becomes hard enough to be used.

The man skilled in the art would conventionally Identify the minimal hardness for the contemplated invention.

Once prepared, the applicator can be attached to a self-adhesive composition. Most preferably the self-adhesive composition is a detergent composition, in the form of a single dose. Examples of detergent that are appropriate for the instant invention are known in the art.

Typically, they are disclosed in the documents U.S. Pat. No. 6,667,286 or WO2008/100393 which content is incorporated herein by reference.

These detergent compositions usually comprise at least one or several of the following adhesion promoters: polyethylene glycol, cellulose, polysaccharides, starches, whereby the cellulose is selected from the group consisting of sodium carboxymethyl cellulose, hydroxyethyl cellulose, and hydroxypropyl cellulose and the polysaccharides is selected from the group consisting of xanthum gum, agar, gelatin gum, acacia gum, carob bean flour, guar gum, and combination thereof; alginates, diurethanes, gelatins, peetines, oleyl amines, alkyl dimethyl amine oxides, alkyl ethyl sulfates, alkyl etoxylate, stearates, alkali metal stearates and combinations thereof.

Without being limited to these examples, the combination can be performed either by inserting the composition into a cavity made from the shape of the applicator, embedding at least one portion of the applicator into the detergent composition itself to improve cohesion between the two elements or fixing the applicator directly onto the surface of the detergent dosage. The detergent composition may be softened or melted to improve the processing of the combination of the two elements into the desired final product.

According to one embodiment, the final products are provided with a film onto the adhesive part for packaging and storage purposes. Typically, each product may be placed on a film individually or placed with other products onto the same film. For example, the film can be made of silicone.

Before application, the user will seize the product with the fingers of one hand, i.e. with the grip portion available on one side of the product, peel the film off the adhesive surface of the product on the opposite side of the product with the other hand and apply directly the product onto the wall of the sanitary element with an appropriate pressure. Once the product is applied, the user only has to release the grip or break it with a twist before using it.

In the invention, all percentages are by weight, based on the total weight of the applicator, unless specified otherwise.

1. A non-soluble and non-removable applicator for self-adhesive composition, preferably a self-adhesive detergent composition.

2. The applicator according to claim 1, comprising at least one paper and paperboard based materials; biodegradable plastics; wax based materials; cotton based materials; wood based materials; or soap based materials; preferably a biodegradable material.

3. The applicator according to claim 1 made of one or mixtures of materials selected among aromatic polyesters, polyhydroxyalkanoates (PHAs) such as poly-3-hydroxybutyrate (PHB), polyhydroxyvalerate (PHV) and polyhydroxyhexanoate (PHH); polylactic acid (PLA); Polybutylene succinate (PBS), polycaprolactone (PCL) Polyanhydrides; polyvinyl alcohol, starch derivatives cellulose esters such as cellulose acetate and nitrocellulose and their derivatives (celluloid); poly-L-lactide (PLLA) poly-DL-lactide (PDLLA), polyglycolic acid (PGA), modified PET, or mixtures thereof.

4. The applicator according to claim 1, which further comprises a grip portion.

5. The applicator according to claim 4, wherein the grip portion corresponds to a protruding portion or finger receiving cavities.

6. The applicator according to claim 1, which comprises at least two curved arms (3) that are radially oriented,

7. The applicator according to claim 1 which is further comprises pores and/or at least one hole therein.

8. The applicator according to claim 1, which further comprises an additive such as disinfectants, perfume, insecticides enzymes, colored particles, preservatives, biocides, anti-lime scale, dyes, colorant and/or antibacterial agents therein in an amount of from 0 to 20 wt % of the total weight of the applicator, preferably from 1 to 5 wt %.

9. A self-adhesive product comprising a self-adhesive unit composition, preferably a self-adhesive detergent unit composition, which is attached to non-soluble and non-removable applicator as defined according to claim 1.

10. The self-adhesive product according to claim 9, wherein at least one portion of the self-adhesive unit is left available to adhere to a wall and one portion is left available to the surrounding water after application.

11. The self-adhesive product according to claim 9 wherein at least part of the applicator is embedded into the self-adhesive unit composition.

12. The self-adhesive product according to claim 9, which further comprises one of its sides a peelable film onto the self-adhesive composition.

13. A process for the manufacture of an applicator according to claim 1, comprising (a) the mixing of the ingredients into a solvent or mixture of solvents, (h) removing at least part of the solvent to harden the form thus obtained and (c) shaping the paste thus obtained into the desired shape by molding or injection.

14. Use of the self-adhesive product according to claim 9 into a sanitary element, preferably a toilet basin.

15. Use according to claim 14 for cleaning, disinfecting and/or deodorizing said sanitary element.
